(19) United States
(12) Patent Application Publication
(10) Pub. No.: US 2025/0115493 A1
(43) Pub. Date: Apr. 10, 2025

(54) METHODS AND CONTROLLER FOR DETERMINING HYDROGEN SULFIDE TREATMENT DOSAGE

(71) Applicant: HACH COMPANY, Loveland, CO (US)

(72) Inventors: Vishnu RAJASEKHARAN, Fort Collins, CO (US); Matthew GRAY, Lafayette Hill, PA (US); Russell YOUNG, Loveland, CO (US)

(73) Assignee: HACH COMPANY, Loveland, CO (US)

(21) Appl. No.: 18/377,587

(22) Filed: Oct. 6, 2023

(51) Int. Cl. C02F 1/00; C02F 1/68; C02F 101/10

(52) U.S. Cl. CPC C02F 1/008; C02F 1/68; C02F 2101/101; C02F 2209/26; C02F 2209/265

(57) ABSTRACT

A method for controlling a hydrogen sulfide concentration of a wastewater stream, the method including measuring a hydrogen sulfide concentration in one phase of the wastewater stream. At least one additional parameter of the wastewater stream is measured, and a hydrogen sulfide concentration of the other phase of the wastewater stream is calculated with a mathematical model that characterizes the hydrogen sulfide concentration in the other phase based on a set of variables that includes the measured hydrogen sulfide concentration in the one phase and the measured at least one additional parameter. Based on the calculated hydrogen sulfide concentration of the other phase, a treatment dosage of a treatment agent that reduces the hydrogen sulfide concentration of the wastewater stream is determined and applied to the wastewater stream.

### BACKGROUND

Hydrogen sulfide (H₂S) is a major concern in sewer networks. It is a malodorous, highly toxic gas with the characteristic smell of rotten eggs, and it is corrosive to concrete and metal.

Hydrogen sulfide's effects are noticeable when released in the gas phase, for example at concentrations of >0.5 ppm. When released into the atmosphere, for example in a sewer or urban area, H₂S causes unpleasant and strong malodors. At higher concentrations, H₂S can be lethal.

A chemical treatment, such as ferric chloride, bioxide, or hydrogen peroxide, is often applied to the wastewater stream to reduce or control H₂S. A lack of predictability and certainty in the H₂S concentration may lead to an under treatment or over treatment of the wastewater stream. Over treating the system with too much chemical treatment agent can unnecessarily increase costs associated with excess treatment agent and its removal from the water stream. On the other hand, if an insufficient amount of the chemical treatment agent is added, H₂S concentrations become high in manhole areas and H₂S scrubbing systems which can cause customer complaints due to odors, creates health risks, and causes equipment failure due to corrosion. More accurate treatments of the wastewater stream would result in less corrosion of the wastewater stream including infrastructure such as pipes and concrete, less odor, and less downtime and maintenance of sensors and H₂S scrubbers.

Monitoring of a wastewater stream atmosphere for H₂S is often challenging because of the harsh environment, associated with high humidity and toxicity. Because of the harsh environment and corrosive conditions, calibration and maintenance of the H₂S sensors and equipment are frequently needed, especially gas phase H₂S sensors. As such, sensors are often taken offline or rotated at regular intervals for service, maintenance, or refreshment periods as recommended by the manufacturer.

When a sensor is taken offline, there is a period of time where a measurement of H₂S in one phase is not available. Thus, an effective amount of chemical treatment of the wastewater is not known. The wastewater is then often under treated or over treated with the chemical treatment.

In addition, when the sensor is taken offline and the measurement of H₂S in one phase is not available, it is difficult to accurately predict a downtime or a maintenance schedule of a H₂S gas scrubber configured to remove H₂S from the wastewater stream and other sensors and equipment in the wastewater system. This can lead to unexpected breakdowns or maintenance of the H₂S gas scrubber or other sensors and equipment.

Accordingly, there remains a need for improved devices, methods, or systems that provide accurate H₂S predictions for one phase, such as when a sensor is not available to determine the H₂S concentration in that phase, and can implement an optimal amount of treatment for reducing H₂S.

### SUMMARY

In one aspect, this disclosure provides a method and controller for determining H₂S treatment dosage that reduces or eliminates these drawbacks.

In one aspect, this disclosure provides a method for controlling a H₂S concentration of a wastewater stream, the method comprising measuring, with a sensor, a H₂S concentration in one phase of the wastewater stream, including either (i) a liquid phase concentration of H₂S of the wastewater stream or (ii) a gas phase concentration of H₂S of the wastewater stream, measuring, with a sensor, at least one additional parameter of the wastewater stream, calculating a H₂S concentration of the other phase of the wastewater stream with a mathematical model that characterizes the H₂S concentration in the other phase based on a set of variables that includes (i) the measured H₂S concentration in the one phase and (ii) the measured at least one additional parameter, based on the calculated H₂S concentration of the other phase, determining a treatment dosage of a treatment agent that reduces the H₂S concentration of the wastewater stream, and applying the determined treatment dosage of the treatment agent to the wastewater stream.

In another aspect, this disclosure provides a method for controlling a H₂S concentration of a wastewater stream, the method comprising measuring, with a sensor, a H₂S concentration in one phase of the wastewater stream, including either (i) a liquid phase concentration of H₂S of the wastewater stream or (ii) a gas phase concentration of H₂S of the wastewater stream, measuring, with a sensor, at least one additional parameter of the wastewater stream, calculating a H₂S concentration of the other phase of the wastewater stream with a mathematical model that characterizes the H₂S concentration in the other phase based on a set of variables that includes (i) the measured H₂S concentration in the one phase and (ii) the measured at least one additional parameter, and based on the calculated H₂S concentration, taking at least one corrective action on a H₂S gas scrubber that is configured to remove H2S from the wastewater stream.

In another aspect, this disclosure provides a controller for controlling a H₂S concentration of a wastewater stream, the controller including at least one processor that is configured to (i) receive signals indicative of a measured H₂S concentration in one phase of the wastewater stream, including either (i) a liquid phase concentration of H₂S of the wastewater stream or (ii) a gas phase concentration of H₂S of the wastewater stream, (ii) receive signals indicative of at least one additional measured parameter of the wastewater stream, and (iii) calculate a H₂S concentration of the other phase of the wastewater stream with a mathematical model that characterizes the H₂S concentration in the other phase based on a set of variables that includes (i) the measured H₂S concentration in the one phase and (ii) the measured at least one additional parameter.

### BRIEF DESCRIPTION OF THE DRAWINGS

FIG. 1 is a graph depicting an empirical relationship between a temperature of a wastewater stream and a concentration H₂S(l) in a liquid phase of the wastewater stream.

FIG. 2 is a graph depicting an empirical relationship between a concentration H₂S(g) in a gaseous phase above the wastewater stream and a concentration H₂S(l) in the liquid phase of the wastewater stream.

FIG. 3 is a schematic diagram of a H₂S treatment system; and

FIG. 4 is a schematic diagram illustrating a probe for validating accuracy of a calculated concentration H₂S(g) in a gaseous phase above the wastewater stream.

### DETAILED DESCRIPTION OF EMBODIMENTS

In the following description, numerous details are set forth to provide an understanding of the present disclosure. However, it may be understood by those skilled in the art that the methods and systems of the present disclosure may be practiced without these details and that numerous variations or modifications from the described embodiments may be possible.

In a wastewater stream, H₂S is formed in the liquid phase under anaerobic conditions when sulfate is biologically reduced by anaerobic bacteria (e.g., Desulfovibrio) to sulfide. The following equations may represent the generation of H₂S from sulfate and anaerobic bacteria.

$${SO}_{4}^{2 -} + organic matter + anaerobic bacteria \to {S}_{2}^{-} + {H}_{2} O + {CO}_{2} {S}_{2}^{-} + 2 {H}^{+} \to {H}_{2} S$$

As used herein, wastewater may include but is not limited to water including municipal wastewater, industrial wastewater, wastewater sludge, sewage, contaminated water, and/or polluted water.

Disclosed herein are methods, systems, and devices for determining an optimal dosage amount of treatment to be added to a wastewater stream or wastewater system to reduce or remove H₂S. For example, the disclosed embodiments determine the optimal or smallest effective amount of treatment for achieving a desired amount of H₂S in a wastewater stream by using at least one measured wastewater parameter, a measured concentration of H₂S in either the liquid phase or the gaseous phase of the wastewater stream, and at least one mathematical model that calculates the H₂S concentration in the other of either the liquid phase or the gaseous phase of the wastewater stream based on the at least one measured wastewater parameter. As explained below, the mathematical model can be a deterministic model, a data analytics model, or a combination of both of these models.

Embodiments of the invention can overcome drawbacks of the prior art by employing techniques to continuously or periodically determine the optimal dosage for meeting the treatment goal. The disclosed embodiments can use a measured value of H₂S in one phase, other measured parameters of a wastewater stream, and theoretical and/or empirical relationships to determine a predicted H₂S content in the other phase. The calculated H₂S content can then be used to calculate the optimal treatment dosage of the chemical treatment agent. The calculated H₂S content can also be used to determine downtime or a maintenance schedule of a H₂S gas scrubber configured to remove H₂S from the wastewater stream or to determine maintenance schedules for other sensors or equipment in the wastewater system.

In some embodiments, the H₂S content is only measured in the one phase. Accordingly, the H₂S content in the other phase can be determined when a sensor for the H₂S content in the other phase is offline or otherwise unavailable.

As explained below, embodiments of the invention can reduce waste and costs as compared to prior methods and devices that administer excess treatment or not enough treatment to the wastewater and that are not able to accurately predict downtime or a maintenance schedule of the H₂S gas scrubbers or monitoring equipment.

### Deterministic Model

A deterministic mathematical model may utilize a measured value of H₂S content in one phase (either H₂S(l) or (g)), other measured parameters or variables that impact a concentration of H₂S in the other phase, and a theoretical relationship of those parameters to a concentration of H₂S in the other phase to calculate the predicted H₂S in the other phase. For example, if a system has a functioning H₂S sensor in the liquid phase, the amount of H₂S(l) can be directly measured, and the amount of H₂S(g) can be calculated based on (i) the measured value of H₂S(l); (ii) other measured parameters or variables of the system and/or environment that affect the value of H₂S(g); and (iii) a mathematical model that calculates H₂S(g) based on these variables. Alternatively, the concentration of H₂S(g) may be measured and H₂S(l) may be calculated.

The first variable of the mathematical model is the measured amount of H₂S in one phase of the system, i.e., either H₂S(l) or H₂S(g). Thus, in using embodiments of the invention, the wastewater system will have at least one working sensor in one phase that can output signals that are indicative of the H₂S amount in that phase. H₂S(l) may be measured in mg/L and H₂S(g) may be measured in ppm, for example.

Apart from the measured amount of H₂S in one phase, there are several parameters of the system and/or environment that can be measured and used to predict the H₂S in the other phase. In embodiments, the mathematical model may use only one such parameter, but typically uses a plurality of the parameters such as from 2 to 8 or from 3 to 5, for example. As will be evident form the description below, these parameters can be measured parameters of the wastewater stream or its surrounding environment that can be measured with sensors in real time (e.g., including probes) and/or parameters of the wastewater stream that are known by being previously calculated or determined (e.g., physical parameters of the wastewater stream such as the slope, or possibly average velocity of the stream or hydraulic depth of the stream).

One measured parameter may be a temperature of the wastewater. The relationship between H₂S(l) in the wastewater and H₂S(g) may be dependent on temperature via an Arrhenius relationship. For example, the relationship may be expressed by: H₂S(l)=C₁f(T)*H₂S(g) where C₁ is a coefficient and f(T) is function of temperature.

One measured parameter may be a pH of the wastewater. The concentration of H₂S(l) in the wastewater may be dependent on the pH. For example, the pH may affect the disassociation of H₂S into its ions, HS⁻ and S²⁻, and the respective concentrations of HS⁻ and S²⁻ may be functions of pH and the concentration of H₂S(l). Thus, a sum of total sulfide in the wastewater may be expressed as: Total Sulfide Concentration=H₂S(l)+H₂S(l)*f₁(pH)+H₂S(l)*f₂(pH) where f₁(pH) is 10^{pH-6.7} and f₂(pH) is 10^{pH-12.90}.

The parameters of temperature and pH may be combined for a more accurate or robust model and expressed as: H₂S(g)=C₂(H₂S(l)+H₂S(l)*f₁(pH)+H₂S(l)*f₂(pH))/C₁f(T) where C₂ is a constant.

Various other parameters of the system that affect H₂S can be used in the deterministic model. Examples of such parameters include a measured parameter such as biochemical oxygen demand (“BOD”), a physical parameter of the system such as the slope of the wastewater in the system (“S”), a mean velocity of the wastewater in the system (“V”), and a hydraulic depth (“dₘ”) which is a cross sectional area of the flow divided by the flow width. BOD may be measured in mg/L. S may be measured in m/m and measured from a pump from a wet well lift station to a discharge of a force main, i.e. across the force main. V may be measured in m/s⁻¹ and may be measured at the discharge of the force main. dₘ may be measured in m.

The physical parameters of the system, velocity of the wastewater in the system, and the measurement of organic parameters in the wastewater may be expressed as: H₂S(l)=C₃f(BOD)*f₁(T)-C₄f(S,V)*H₂S(l)*f(dₘ) where C₃ and C₄ are constants, f(BOD) is a function of BOD, f₁(T) is a function of T, f(S,V) is a function of S and V, and f(dₘ) is a function of dₘ.

These parameters may be combined with the temperature and pH for a more accurate or robust model and expressed as: H₂S(g)=C₂*(C₃f(BOD)*f₁(T)-C₄f(S,V)*H₂S(l)*f(dₘ))*(1+f₁(pH)+f₂(pH))/C₁f(T).

A measured parameter of the wastewater stream may include a parameter of the air or atmosphere above the wastewater stream. Any parameters measured may be measured at any location or point in the wastewater system including at the wet well lift station, at the force main, or at a discharge of the force main.

### Data Analytics Model

A data analytics model can utilize empirical relationships of parameters or variables that impact a concentration of H₂S(l) or H₂S(g), and a measured concentration of H₂S in one phase to calculate a concentration of H₂S in the other phase. For example, if a system has a functioning H₂S sensor in the liquid phase, the amount of H₂S(l) can be directly measured, and the amount of H₂S(g) can be calculated based on (i) the measured value of H₂S(l); (ii) other measured parameters or variables of the system and/or environment that affect the value of H₂S(g); and (iii) empirical relationships between the other measured parameters or variables and the amount of H₂S(g). Alternatively, the concentration of H₂S(g) may be measured and H₂S(l) may be calculated.

Empirical data shows that the release of H₂S into the atmosphere from the wastewater stream is dependent on various wastewater quality parameters. The primary parameters are H₂S(l), pH of the wastewater, a flow rate of the wastewater, temperature of the wastewater, and a concentration of a H₂S treatment agent (e.g., quencher) in the wastewater, for example FeCl₃. Secondary parameters include an oxygen concentration in the wastewater and a sulfate concentration in the wastewater. Each parameter may have varying degrees of impact on the H₂S(g). Additional parameters may include but are not limited to, for example, nitrate concentration of the wastewater, a conductivity of the wastewater, a hardness of the wastewater, oxidation-reduction potential, a SO₄ concentration of the wastewater, an alkalinity of the wastewater, a location of the sensors, a wind speed of the atmosphere above the wastewater, a distance between H₂S(g) and H₂S(l) sensors, turbidity of the wastewater, a total organic carbon content of the wastewater, an ultraviolet adsorption of the wastewater (UV254), a total suspended solids content of the wastewater, a zeta potential, vapor pressure of the wastewater, and a temperature of the air above the wastewater stream. In addition to the measured concentration of H₂S in one phase, the data analytics model may use one or a plurality of additional parameters such as from 2 to 30, from 2 to 8 or from 3 to 5, for example. These parameters can be measured parameters of the wastewater stream or its surrounding environment that can be measured with sensors in real time (e.g., including probes) and/or parameters of the wastewater stream that are known by being previously calculated or determined.

The data analytics model may quantify the H₂S(g) or H₂S(l) by using a combination of parameters with weighting coefficients depending on the impact of each parameter. In the model for calculating H₂S(g) amounts, the H₂S(l) typically has the highest impact on the H₂S(g), followed by temperature of the wastewater, pH of the wastewater, flow rate of the wastewater, and the concentration of a H₂S quencher in the wastewater. The degree of impact on H₂S(g) by each parameter can be weighted with a coefficient in the mathematical model. Variables or parameters may be included to increase the robustness of the model.

The data analytics model may be expressed generally as y=Xβ+ε where y is a target variable to be predicted/measured, X is a predictor (a quantity of a measured variable), β is a weighted coefficient of a corresponding a predictor, and e denotes the next predictor and coefficient that may be utilized in the equation. For example, the data analytics model may be expressed as:

$$H 2 S ( g ) = {β}_{1} ( pH ( X 1 ) ) + {β}_{2} ( H 2 S ( l ) ( X 2 ) ) + {β}_{3} ( Flow ( X 3 ) ) + {β}_{4} ( Temp ( X 4 ) ) + {β}_{5} ( Flow ( X 5 ) ) + {β}_{6} ( Turbidity ( X 6 ) ) + {β}_{7} ( TOC ( X 7 ) ) + {β}_{8} ( UV 254 ( X 8 ) ) + {β}_{9} ( TSS ( X 9 ) ) + {β}_{10} ( Zeta Potential ( X 10 ) ) + {β}_{11} ( H 2 S quencher ( Fe Cl 3 ( X 11 ) ) + {β}_{12} ( Nitrate ( X 12 ) ) + {β}_{13} ( Conductvity ( X 13 ) ) + {β}_{14} ( Hardness ( X 14 ) ) + {β}_{15} ( ORP ( X 15 ) ) + ( + {β}_{16} ( {β}_{17} ( SO 4 ( X 17 ) ) + {β}_{18} ( Akalinity ( X 18 ) ) + {β}_{19} ( Location ( X 19 ) + {β}_{20} ( \text{} Windspeed ( X 18 ) + {β}_{21} ( Distance between H 2 S ( g ) to H 2 S ( l ) ( X 18 ) + ) ) ) ) ) )$$

$$or$$

$$y = ( {β}_{1} , {β}_{2} , {β}_{3} , {β}_{4} … {β}_{18} ) \cdot ( \begin{matrix}pH \\ H 2 S ( l ) \\ Temp …\end{matrix} ) .$$

In the above equation, X represents a measured quantity of the preceding parameter, e.g. X₁ represents a measured quantity of pH, X₂ represents a measured quantity of H₂S(l), etc. X₃ flow may represent a measured quantity of an uphill flow, such as an uphill flow rate, and X₅ flow may represent a measured quantity of a downhill flow, such as a downhill flow rate. A coefficient β may be determined by a correlation of the corresponding predictor X to the target variable y. For example, empirical data may be utilized to determine the coefficient β for each variable X by a comparison of empirical data for X to a concentration of H₂S.

The above equation may serve as a foundation for the data analytics mode and may be manipulated, for example, depending on the availability of measurements of specific parameters, the weight of coefficients for a specific system, or the measured quantity of a parameter in the specific system. For example, a variable may be removed from the equation if a measurement of the variable is not available for a specific system (i.e. there is no sensor available to measure the parameter at a facility or site) or the contribution of that variable and/or its coefficient in relationship to the concentration of H₂S(g) is determined to be negligible in the specific system.

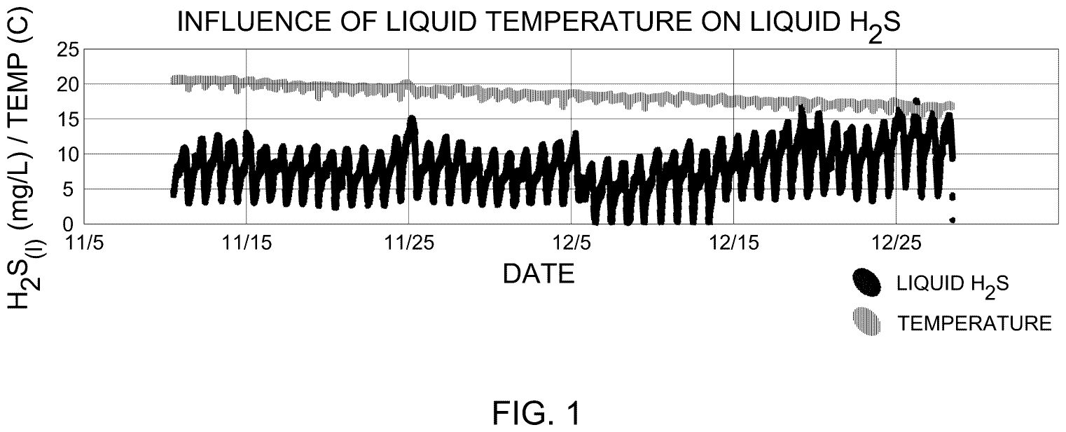

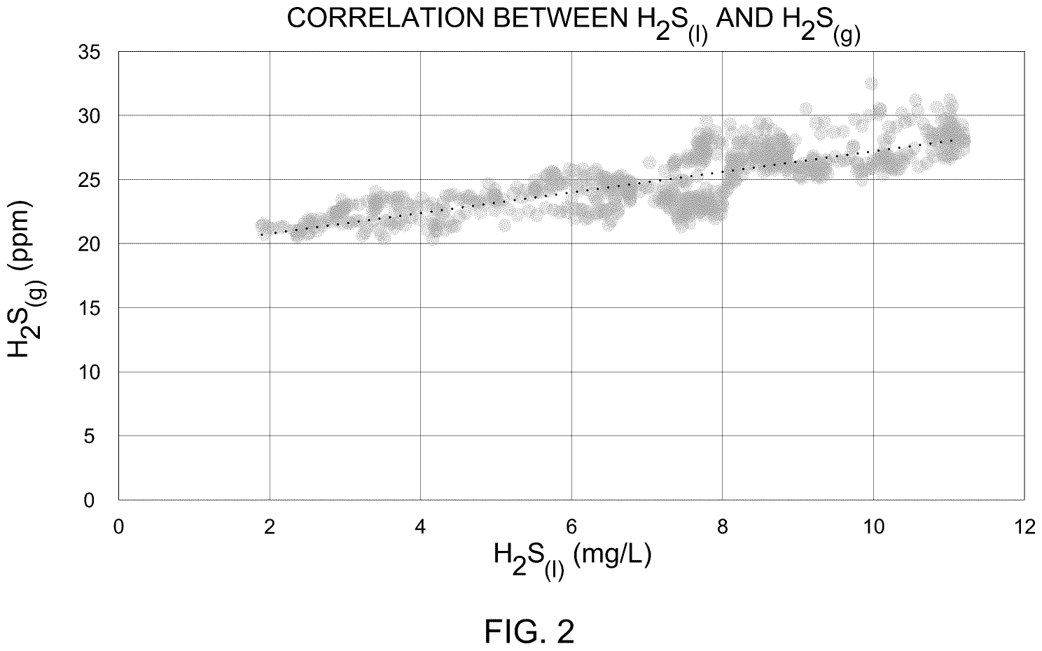

FIGS. 1 and 2 are examples of empirical relationships that may be utilized in the data analytics approach to determine a coefficient β for a corresponding predictor X. An example of an empirical relationship between a temperature of the wastewater stream and concentration of H₂S(l) is seen in FIG. 1. The temperature of the wastewater stream is measured in Celsius and the concentration of H₂S(l) is measured in mg/L. The graph depicts the empirical, measured relationship between the two parameters at various dates in a certain system. As shown in FIG. 1, as the temperature decreases, generally H₂S(l) increases. Accordingly, the empirical data of FIG. 1 may be used to determine a coefficient β for the parameter of temperature for the target variable of H₂S(l).

FIG. 2 depicts an empirical relationship between a concentration of H₂S(g) measured in ppm and a concentration of H₂S(l) measured in mg/L. As shown in FIG. 2, as H₂S(l) increases, generally H₂S(g) increases. Accordingly, the empirical data of FIG. 2 may be used to determine a coefficient β for the parameter of H₂S(l) for the target variable of H₂S(g).

Other empirical relationships can be determined for various other system variables. Depending on the variable, the empirical relationships can be determined at each facility/site, or possibly certain empirical relationships would be applicable between sites. Thus, the coefficient β for each predictor X may be dependent upon the facility/site of the system.

### Combined Model

The mathematical models may be used independently or in conjunction with each other for greater accuracy or to minimize error. In one embodiment, the data analytics mathematical model may compensate or supplement the deterministic mathematical model by including empirical relationships between the parameters or variables for a more accurate prediction or determination of H₂S concentration. For example, the deterministic model may be used to calculate a H₂S concentration in one phase of the wastewater system. A coefficient or constant used in the deterministic model may then be weighted with a coefficient β of the data analytics model for the corresponding calculated variable. Alternatively or in addition, measured parameters not initially included in the deterministic model may be added to the deterministic model with the corresponding coefficient β as used in the data analytics model. For example, a specific parameter may not be utilized by the data analytics model. Accordingly, a measured value of that specific parameter may be weighted by its corresponding coefficient β from the data analytics model. The result may be added to the deterministic model for a more accurate determination of the H₂S concentration.

In another embodiment, the deterministic mathematical model may compensate or supplement the data analytics mathematical model by including theoretical relationships between the parameters or variables for a more accurate prediction or determination of H₂S concentration. For example, the data analytics model may be used to calculate a H₂S concentration in one phase of the wastewater system. An unmeasured parameter may then be calculated by the deterministic model and a calculated value of that unmeasured parameter may then be included in the data analytics model and weighted with the corresponding coefficient of the data analytics model. Alternatively or in addition, a calculated value of a parameter of the deterministic model may be substituted for a measured parameter of the data analytics model.

### Automated H₂S Treatment Dosing System

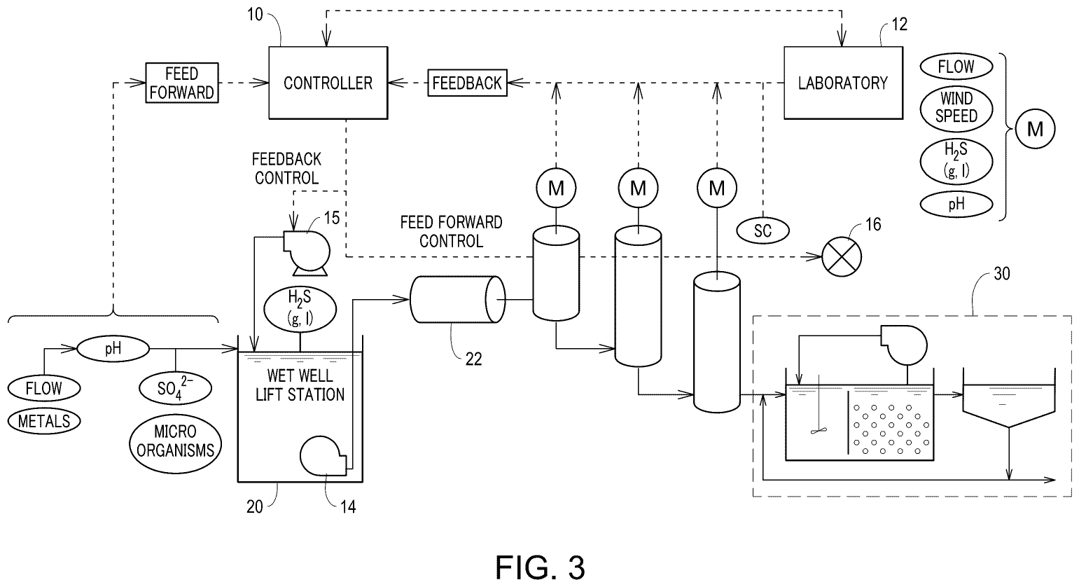

FIG. 3 depicts a controller 10 in communication with a supply pump 15. The supply pump 15 administers a treatment, such as ferric chloride, hydrogen peroxide, bioxide, or other H₂S quenching agents at a wet well lift station 20. The wet well lift station 20 may be at or near the lowest topographical point in the wastewater system. At the wet well lift station 20, a pump 14 pumps the wastewater through a force main 22 to a higher elevation where it is discharged from the force main 22 into an open channel collection system at a point that is near the highest topographical point in the wastewater system. The wastewater then flows downstream towards a treatment plant 30 passing a series of manholes M.

Using methods described herein, treatment of the wastewater stream is controlled, i.e., adjusted and optimized using measured parameters and a mathematical model, by the controller 10 to increase overall efficiency and reduce costs. According to an embodiment, the treatment can be precisely and accurately controlled via the controller 10 by sending control signals to the supply pump 15.

Various control mechanisms can be used in connection with one or more of the above-described mathematical models to accurately control the dosage of the treatment agent, including a feed forward control loop and a feedback control loop, e.g. as shown in FIG. 3.

Feed forward parameter(s) may be measured on-line, upstream of the wet well lift station 20. For example, as shown in FIG. 3, measured parameters may include a pH of the wastewater stream, a flow of the wastewater stream, an SO₄²⁻ concentration of the wastewater stream, a content of metals in the wastewater stream, and a content of microorganisms in the wastewater stream. In addition, in FIG. 3 a concentration of H₂S(g) or H₂S(l) is measured at the wet well lift station 20.

The measured feed forward parameter(s) can be evaluated to adjust the treatment dosage. For example, the controller 10, which is configured to receive the measured feed forward parameter(s), can be configured to evaluate the measured parameter(s) by the deterministic mathematical model, the data analytics mathematical model, or a combination thereof and calculate a H₂S concentration. Then controller may calculate a treatment dosage corresponding to the calculated H₂S concentration. The calculated treatment dosage can be output by the controller 10 for automatically controlling a supply pump 15 to administer the calculated treatment dosage or outputting instructions to a user (e.g., via a user interface) to adjust the treatment dosage.

The feedback parameter(s) may be measured on-line, downstream of the wet well lift station, for example in by a sensor in a manhole M or by a sensor SC at a location at or near a site of a scrubber 16. As shown in FIG. 3, measured parameters may include a concentration of H₂S(g) or H₂S(l), a pH of the wastewater stream, a flow of the wastewater stream, and a wind speed of the atmosphere above the wastewater.

Feedback parameters may also include parameters measured in a laboratory 12. For example, parameters measured in a laboratory 12 may include a concentration of iron, a concentration of SO₄²⁻ or another sulfate concentration of the wastewater stream, and BOD of the wastewater stream. An abundance of free iron in the wastewater stream is indicative of overdosing of the treatment FeCl₃. An abundance of a sulfate concentration is indicative that the anaerobic bacteria have not used the sulfate to generate H₂S.

The measured feedback parameter(s) can be evaluated to adjust the treatment dosage accordingly. For example, the controller 10, which is configured to receive the measured feedback parameter(s), can be configured to evaluate the measured parameter(s) by the deterministic mathematical model, the data analytics mathematical model, or a combination thereof and calculate a H₂S concentration. Then controller may calculate a treatment dosage corresponding to the calculated H₂S concentration. The calculated treatment dosage can be output by the controller 10 for automatically controlling a supply pump 15 to administer the calculated treatment dosage or outputting instructions to a user (e.g., via a user interface) to adjust the treatment dosage.

Measured feedback or feed forward parameters may be chosen from amongst parameters already being measured in a wastewater system. The parameters selected for use in a mathematical model are not limited to those described and any combination of parameters may be utilized. Additional parameters may be included for greater accuracy and robustness of the model, leading to a more accurate prediction or determination of the H₂S concentration. Thus, the controller 10 may be retrofitted onto an existing wastewater system and utilize pre-existing sensors to predict or determine the H₂S(g) concentration or the H₂S(l) concentration and determine a treatment dosage.

When predicting or determining the H₂S concentration, the controller 10 may utilize the feed forward parameters, feedback parameters, or a combination thereof. Once the H₂S concentration is predicted or determined by the controller 10, the controller 10 may compare the predicted or determined concentration to a target amount or range or threshold. If the predicted or determined H₂S concentration exceeds the target amount or range, the controller may determine an adequate minimal amount of treatment that a supply pump 15 should supply to the wastewater stream to reduce the H₂S concentration to within or below the target amount or range. If the predicted or determined H₂S concentration is within or below the target amount or range, the controller 10 may repeat the process until the predicted or determined H₂S concentration exceeds the target amount or range.

The controller 10 may also enable proactive maintenance and of H₂S monitoring equipment, such as the sensors measuring various parameters, and/or a scrubber 16. The scrubber 16 may remove H₂S in the wastewater or in a gaseous phase above the wastewater before the wastewater enters the treatment plant 30. The measured feed forward and/or feedback parameters may be utilized to predict or determine a concentration of H₂S at a location at or immediately before any monitoring equipment and/or the scrubber 16. A more accurate prediction or determination of H₂S at the location of the monitoring equipment or scrubber 16 enables a better prediction or determination of abrasive conditions of the equipment or scrubber 16. In addition, it enables a more accurate estimation of H₂S being removed by the scrubber 16. This enables better prediction of maintenance and scheduling of downtime of the equipment or scrubber 16.

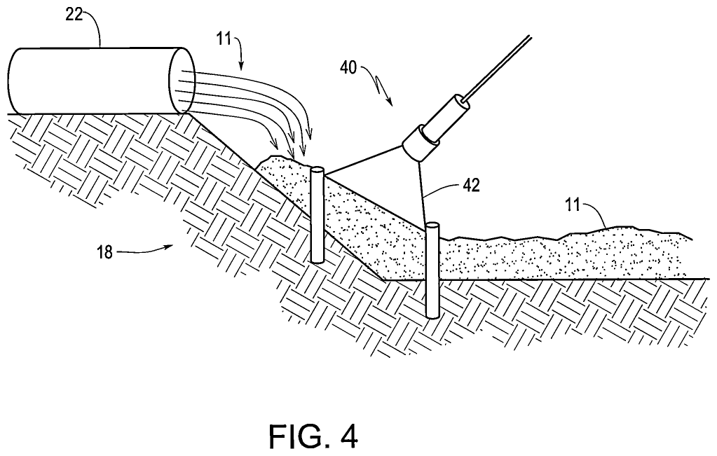

Verification and/or adjustment of the mathematical models may be continuously or periodically performed using the real time feedback measurement(s), for example with a H₂S probe 40 shown in FIG. 4. Other continuous on-line feedback measurements or laboratory analysis of samples collected for verification and adjustment of the model may be used.

The probe 40 is located at a discharge site of the force main 22. The probe 40 includes a H₂S sensor and sensor holder attached to a hood 42, configured to capture H₂S gas in a controlled environment above a wastewater stream 11 in a sewer collection channel 18. The probe 40 may include an air inlet and a fan/pump for a controlled gas flow.

The probe 40 may provide a measured concentration of H₂S(g). The measured concentration may be sent to the controller 10, and the controller 10 may compare the predicted or determined H₂S(g) concentration to the concentration measured by the probe 40. The model or combination of models utilized by the controller 10 may be adjusted to match the H₂S(g) concentration measured by the probe 40. For example, additional parameters may be added to or removed from the model or combination of models to adjust the measured or predicted H₂S concentration. In addition or alternatively, variables within the model, such as weighted coefficients, may be adjusted.

The controller 10 can include hardware, such as a circuit for processing digital signals and a circuit for processing analog signals, for example. The controller may include one or a plurality of circuit devices (e.g., an IC) or one or a plurality of circuit elements (e.g., a resistor, a capacitor) on a circuit board, for example. The controller 10 may be a central processing unit (CPU) or any other suitable processor, and can likewise include a plurality of processors, The controller 10 may be or form part of a specialized or general purpose computer or processing system that may implement machine learning algorithms according to disclosed embodiments. One or more controllers, processors, or processing units, memory, and a bus that operatively couples various components, including the memory to the controller, may be used. The controller 10 may include a module that performs the methods described herein. The module may be programmed into the integrated circuits of the processor, or loaded from memory, storage device, or network or combinations thereof. For example, the controller 10 may execute operating and other system instructions, along with software algorithms, machine learning algorithms, computer-executable instructions, and processing functions. In some embodiments, the controller may be a series or a plurality of controllers.

The controller may 10 be operational with numerous other general purpose or special purpose computing system environments or configurations. Examples of well-known computing systems, environments, and/or configurations that may be suitable for use with the disclosed embodiments may include, but are not limited to, personal computer systems, server computer systems, thin clients, thick clients, handheld devices, such as tablets and mobile devices, laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Various components of the treatment system may be connected with each other via any type of digital data communication such as a communication network. Data may also be provided to the controller 10 through a network device, such as a wired or wireless Ethernet card, a wireless network adapter, or any other device designed to facilitate communication with other devices through a network. The network may be, for example, a Local Area Network (LAN), Wide Area Network (WAN), and computers and networks which form the Internet. The system may exchange data and communicate with other systems through the network. For example, the method may be practiced in clouding computing environments, including public, private, and hybrid clouds. The method can also or alternatively be practiced in distributed cloud computing environments where tasks are performed by remote processing devices that are linked through a communications network. In a distributed cloud computing environment, program modules may be located in both local and remote computer system storage media including memory storage devices. The system may be also be configured to work offline.

The present disclosure may further relate to a non-transitory computer-readable storage medium configured to store a computer-executable program that causes a computer to perform functions, such as those for implementing the disclosed methods and models. The computer-readable storage medium may further store the real time data collected by the controller 10 and computer-executable instructions.

The storage medium may include a memory and/or any other storage device. The memory may be, for example, random-access memory (RAM) of a computer. The memory may be a semiconductor memory such as an SRAM and a DRAM. The storage device may be, for example, a register, a magnetic storage device such as a hard disk device, an optical storage device such as an optical disk device, an internal or external hard drive, a server, a solid-state storage device, CD-ROM, DVD, other optical or magnetic disk storage, or other storage devices.

It will be appreciated that the above-disclosed features and functions, or alternatives thereof, may be desirably combined into different methods and systems. Also, various alternatives, modifications, variations or improvements may be subsequently made by those skilled in the art, and are also intended to be encompassed by the disclosed embodiments. As such, various changes may be made without departing from the spirit and scope of this disclosure.

What is claimed is:

1. A method for controlling a hydrogen sulfide concentration of a wastewater stream, the method comprising:
measuring, with a sensor, a hydrogen sulfide concentration in one phase of the wastewater stream, including either (i) a liquid phase concentration of hydrogen sulfide of the wastewater stream; or (ii) a gas phase concentration of hydrogen sulfide of the wastewater stream;
measuring, with a sensor, at least one additional parameter of the wastewater stream;
calculating a hydrogen sulfide concentration of the other phase of the wastewater stream with a mathematical model that characterizes the hydrogen sulfide concentration in the other phase based on a set of variables that includes (i) the measured hydrogen sulfide concentration in the one phase; and (ii) the measured at least one additional parameter;
based on the calculated hydrogen sulfide concentration of the other phase, determining a treatment dosage of a treatment agent that reduces the hydrogen sulfide concentration of the wastewater stream; and
applying the determined treatment dosage of the treatment agent to the wastewater stream.

2. The method of claim 1, wherein the mathematical model includes a deterministic model that is based on (i) a theoretical relationship between the measured at least one additional parameter and the hydrogen sulfide concentration of the other phase; and (ii) a theoretical relationship between the hydrogen sulfide concentration in the one phase and the hydrogen sulfide concentration of the other phase.

3. The method of claim 1, wherein the mathematical model includes an empirical model that is based on correlations of (i) empirical data of the measured at least one additional parameter and the hydrogen sulfide concentration of the other phase; and (ii) empirical data of the hydrogen sulfide concentration in the one phase and the hydrogen sulfide concentration of the other phase.

4. The method of claim 2, wherein the deterministic model is also based on correlations of empirical data of the measured at least one additional parameter and the hydrogen sulfide concentration of the other phase.

5. The method of claim 2, wherein the deterministic model is also based on correlations of empirical data of the hydrogen sulfide concentration in the one phase and the hydrogen sulfide concentration of the other phase.

6. The method of claim 1, wherein the step of determining the treatment dosage includes comparing the calculated hydrogen sulfide concentration of the other phase to a predetermined threshold value of hydrogen sulfide concentration.

7. The method of claim 1, wherein the measured at least one additional parameter of the wastewater stream includes from 2 to 8 measured parameters of the wastewater stream.

8. The method of claim 1, wherein the measured at least one additional parameter of the wastewater stream includes from 3 to 5 measured parameters of the wastewater stream.

9. The method of claim 7, wherein the measured at least one additional parameter of the wastewater stream includes at least two of: (i) a temperature of the wastewater; (ii) a pH of the wastewater; (iii) biochemical oxygen demand of the wastewater; (iii) a concentration of a hydrogen sulfide treatment agent in the wastewater; (iv) an oxygen concentration in the wastewater; and (v) a sulfate concentration in the wastewater.

10. The method of claim 9, wherein the measured at least one additional parameter of the wastewater stream further includes at least one of: (vi) a flow rate of the wastewater; (vii) a turbidity of the wastewater; (viii) a total organic carbon content of the wastewater; (ix) an ultraviolet adsorption of the wastewater; (x) a total suspended solids content of the wastewater; (xi) a zeta potential of the wastewater; (xii) a conductivity of the wastewater; (xiii) a hardness of the wastewater; and (xiv) an oxidation-reduction potential of the wastewater.

11. The method of claim 1, wherein the set of variables further includes at least one known parameter of the wastewater stream.

12. The method of claim 11, wherein the at least one known parameter of the wastewater stream includes at least one of (i) a slope of the wastewater stream; (ii) a mean velocity of the wastewater stream; and (iii) a hydraulic depth of the wastewater stream.

13. A method for controlling a hydrogen sulfide concentration of a wastewater stream, the method comprising:
measuring, with a sensor, a hydrogen sulfide concentration in one phase of the wastewater stream, including either (i) a liquid phase concentration of hydrogen sulfide of the wastewater stream; or (ii) a gas phase concentration of hydrogen sulfide of the wastewater stream;
measuring, with a sensor, at least one additional parameter of the wastewater stream;
calculating a hydrogen sulfide concentration of the other phase of the wastewater stream with a mathematical model that characterizes the hydrogen sulfide concentration in the other phase based on a set of variables that includes (i) the measured hydrogen sulfide concentration in the one phase; and (ii) the measured at least one additional parameter; and
based on the calculated hydrogen sulfide concentration, taking at least one corrective action on a hydrogen sulfide gas scrubber that is configured to remove hydrogen sulfide from the wastewater stream.

14. The method of claim 13, wherein the at least one corrective action includes changing a downtime schedule or a maintenance schedule of the hydrogen sulfide gas scrubber.

15. A controller for controlling a hydrogen sulfide concentration of a wastewater stream, the controller including at least one processor that is configured to:
(i) receive signals indicative of a measured hydrogen sulfide concentration in one phase of the wastewater stream, including either (i) a liquid phase concentration of hydrogen sulfide of the wastewater stream; or (ii) a gas phase concentration of hydrogen sulfide of the wastewater stream;
(ii) receive signals indicative of at least one additional measured parameter of the wastewater stream; and
(iii) calculate a hydrogen sulfide concentration of the other phase of the wastewater stream with a mathematical model that characterizes the hydrogen sulfide concentration in the other phase based on a set of variables that includes (i) the measured hydrogen sulfide concentration in the one phase and (ii) the measured at least one additional parameter.

16. The controller of claim 15, wherein the at least one processor is further configured to:
(iv) based on the calculated hydrogen sulfide concentration of the other phase, determine a treatment dosage of a treatment agent that reduces the hydrogen sulfide concentration of the wastewater stream; and
(v) output at least one signal that is indicative of the treatment dosage.

17. The controller of claim 16, wherein the output signal is configured to control a supply pump that administers the determined treatment dosage.

18. The controller of claim 15, wherein the controller is further configured to:
(iv) determine, based on the calculated hydrogen sulfide concentration, a downtime schedule or a maintenance schedule of a hydrogen sulfide gas scrubber that is configured to remove hydrogen sulfide from the wastewater stream.
